(19) United States
(12) Patent Application Publication
(10) Pub. No.: US 2009/0009357 A1
(43) Pub. Date: Jan. 8, 2009

(54) Method and system for preventing accidents

(75) Inventors: Kjell-Harald Heen, Oslo (NO); Morten H. Helvig, Sandnes (NO)

Correspondence Address: MERCHANT & GOULD PC, P.O. BOX 2903, MINNEAPOLIS, MN, 55402-0903, US

(73) Assignee: Unified Messaging Systems AS, Oslo (NO)

(21) Appl. No.: 11/901,783

(22) Filed: Sep. 19, 2007

Related U.S. Application Data
(60) Provisional application No. 60/826,090, filed on Sep. 19, 2006.

(30) Foreign Application Priority Data
Sep. 19, 2007 (NO) 20064234

(51) Int. Cl. G08B 1/08

(52) U.S. Cl. 340/825.49

(57) ABSTRACT

A method and a system for preventing an undesired incident between moving objects within a defined area which comprise establishing an overview of the objects by using a combination of data received from positioning means installed in the objects and sound data from the objects to be monitored. From data received, future expected position is computed, and warning is initiated if necessary.

### TECHNICAL FIELD

The present invention relates to the monitoring of objects with a view to preventing accidents. More specifically, the invention describes a method and a system for preventing accidents between aircraft, and between aircraft and vehicles at an airport, based on monitoring of position and expected movement.

### BACKGROUND OF THE INVENTION

Accidents between aircraft and vehicles at airports are not uncommon and are known as runway incursions. This term is defined as any undesired incident at an airport involving an aircraft, vehicle, person or object on the ground that creates a collision hazard or results in a service interruption in that an aircraft is prevented from taking off or landing.

The present invention, described as a RIAS-concept (Runway Incursion Avoidance System), relates to a system that is intended to prevent undesired incidents at an airport.

Accidents between various objects at an airport are a major problem and the cause of some of the biggest accidents in aviation history. At the same time, there are many such near accidents every day throughout the world. In the USA alone, from 1997 to 2000, there were some 1500 incidents categorised as runway incursions.

There are many reasons for such near accidents. Those that can be mentioned include airport layout with complex taxiways, signposting, lighting and airfield marking which at times is cryptic. Furthermore, increasing traffic density adds to an increasing danger of runway incursions. Weather conditions and visibility also have an impact since much of the control is carried out visually. Construction work at airports may contribute to there being vehicles with drivers who lack training or experience in driving around at airports.

The handling of runway incursions is one of the areas given top priority in international aviation. The main object of the present invention is to supply a complete system that will solve this problem.

As mentioned, near accidents and so-called runway incursions at airports are the focus of a great deal of attention. The closest prior art comprises the use of units located on all objects that are to be included in the assessment of an imminent undesired incident.

WO 03/107299 teaches an example of a method and a device for providing a warning of a runway incursion. The system is based on there being a dedicated warning unit on board the aircraft that are to use an airport. The system is further based on position determination from GPS and/or the aircraft's own map tracking system. In this way, the pilot of the aircraft can be alerted to the fact that the aircraft has moved into a zone that is protected.

In practice, it will be difficult to implement such a system where all aircraft using an airport must have dedicated warning units for the whole system to work in a satisfactorily safe manner. This is because at most airports where it is relevant to implement a RIAS-system the air traffic is international, with many different types of aircraft from all over the world. Moreover, the system does not take into account other vehicles at the airport which may cause an undesired incident.

The weakness of many of today's conventional tracking systems is that the logic is located on the client, i.e., the object thus lives its own life and cannot be monitored in a larger system. The solutions therefore cannot execute logic which handles relations between objects.

In a conventional system, it is not possible, for example, to set rules between objects which detect critical situations between them.

The present invention will address this and the aforementioned disadvantages of the known systems. By means of a system which has a functionality that includes rules between objects, it will be possible to anticipate critical situations arising from one or more objects being on collision course in relation to each other.

Furthermore, the invention is not dependent upon all objects that are to be monitored being equipped with their own positioning means in order to determine and report position. Instead, only objects which naturally belong to the airport are equipped with such means and report position to a central unit, whilst the position of objects which do not naturally belong to the airport is found by recording the sound generated by, preferably, an aircraft.

The system will thus also be able to detect the movements of vehicles that do not naturally belong to the airport, and which have not been registered as users of the system, i.e., have not been equipped with their own positioning means. It is therefore possible, for example, to detect the movements of a vehicle that commits an incursion into an airport area.

A central unit will gather all the information and form a picture of the movements of objects that are to be monitored, and initiate necessary warning if a critical situation is imminent.

### BRIEF DESCRIPTION OF THE INVENTION

The invention describes a method and a system for preventing an undesired incident between moving objects within a defined area.

The method comprises the following steps which are executed in a central unit:

establishing an overview, including position information, of objects with installed positioning means, and which are within the defined area, the positioning means reporting their position;

establishing an overview of position information of objects without installed position means, based on recording and interpreting a generated acoustic image from the objects;

continuously updating the position information from all objects in order to establish an overview of the movements of the different objects;

computing, from the movements, future direction and speed of the different objects;

making further continuous computations for objects which move at a direction and speed which mean that it can be anticipated that an undesired incident may occur;

providing a warning, so that necessary measures for the object(s) with critical direction and speed may be implemented before an undesired incident occurs.

The moving objects are preferably cars and aircraft, and the defined area is preferably an area of an airport.

The said central unit is a server which receives signals comprising position information from objects equipped with positioning means, and which receives signals that describe the acoustic image from objects not equipped positioning means.

The signals of the central unit are preferably received over WLAN and/or GPRS.

Warning is provided in that the central unit emits a radio signal that can be received and interpreted by one or more objects which may be involved in an undesired incident.

The system for preventing an undesired incident between moving objects within a defined area comprises positioning means installed on objects that are registered in the system, means for recording and interpreting sound from objects without installed positioning mean, and warning means for warning the driver of an object before an undesired incident can occur.

The system further comprises a central unit that is signal-connected to the positioning means and the means for recording and interpreting sound, and also to the warning means, and where the central unit has means for receiving, signal-processing and interpreting signals containing information about the objects in the area in question, and where the central unit further has means for providing a warning to the warning means.

In a preferred embodiment, the system has positioning means in the form of GPS receivers with transmitters for transmitting their respective positions to the central unit.

The means for recording sound are one or more microphones, and the means for interpreting sound are a signal processing unit, and the said signal connection to the system is in the form of a WLAN and/or GPRS network.

The warning means towards objects belonging to the defined area are generated towards separate units mounted in the objects, the warning being generated both acoustically and visually with warning signals preferably transmitted via WLAN and/or GPRS.

Alternatively, the warning signals from the central unit to the warning means may be transmitted by means of automated dial-up via the mobile telephone network or other communication channels such as VHF.

The system may also comprise a GIS-(Geographic Information System) based interface which in real time visualises the movements of all objects within the defined area. Briefly, GIS can be described as an information system for handling geographically related data.

The method and the system are described in more detail in the appended set of claims.

### DETAILED DESCRIPTION OF THE INVENTION

The object of the present invention is to prevent accidents at an airport by using combination of position recording means (GPS), acoustics and advanced 3D graphics.

The use of acoustics has been chosen for a number of reasons. The technology and hardware has advanced so much that it permits real time interpretation of advanced sound signatures. By interpreting sound signals, it is possible to detect aircraft types, and whether they are landing or taking off, and it is possible to detect the signs of an incident before it happens, e.g., racing of an engine in the wrong place. Furthermore, acoustics do not require the installation of any form of technology on aircraft and also have no effect on routines on board the aeroplanes. Acoustics are complementary to GPS technology.

A system according to the invention will be able to prevent accidents in an optimal manner without interfering with existing airport systems, infrastructures, aircraft equipment and cockpit routines.

The system will monitor the movement of vehicles on an airport area and the movement of aircraft on taxiway and runway. A monitoring of this kind will mean that the system is able to anticipate undesired incidents and initiate a warning. The system has functionality for registering vehicles and setting access control for each vehicle in the form of a “geofence” which can be activated or deactivated for a relevant vehicle. The system can be implemented with automatic storage of deviation incidents so that they can be played back and shown again.

The invention will be described in more detail below with reference to the figures wherein:

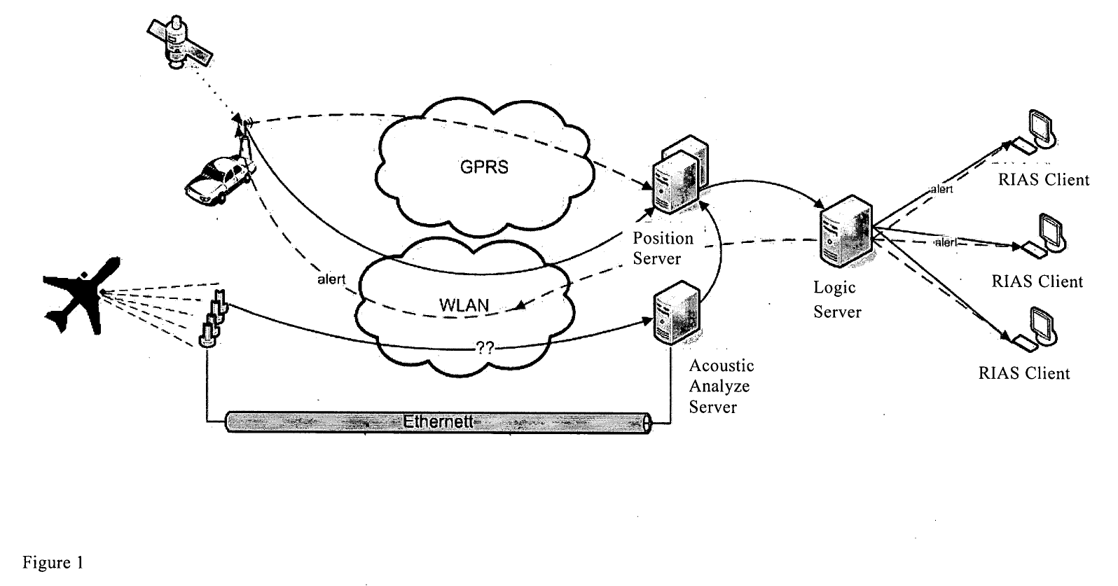

FIG. 1 shows a general architecture of the system;

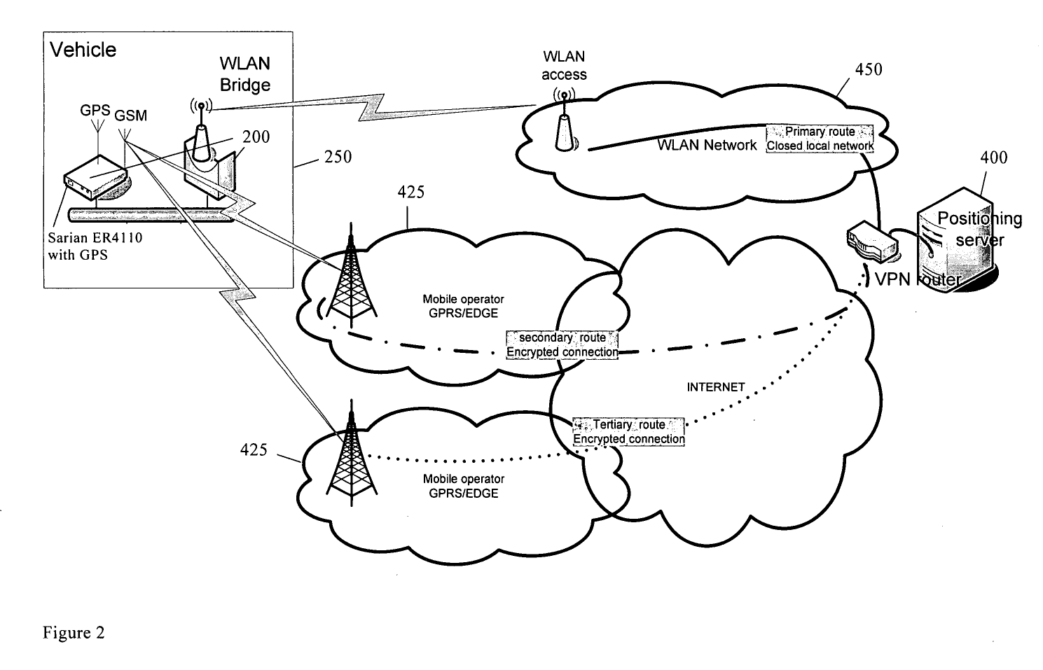

FIG. 2 shows how redundancy of data transmission is dealt with;

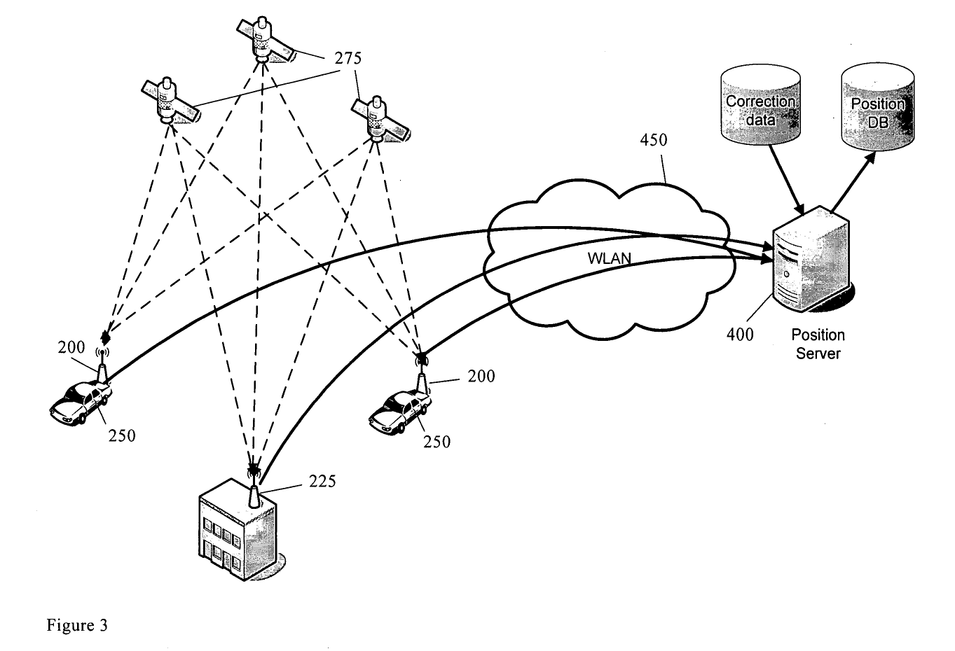

FIG. 3 shows how quality assurance of positions is carried out;

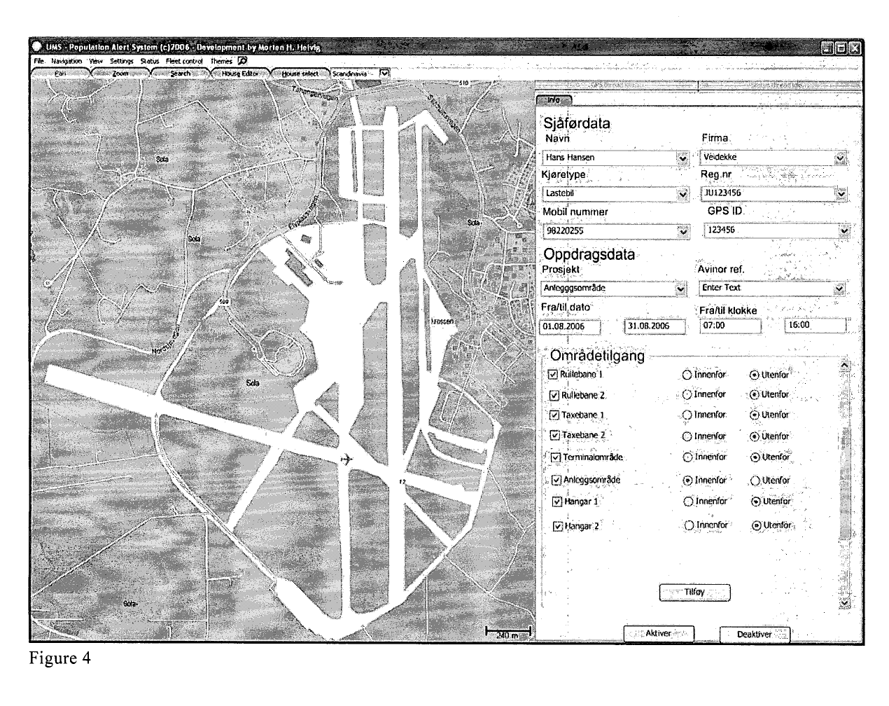

FIG. 4 shows an example of an interface for registration of objects;

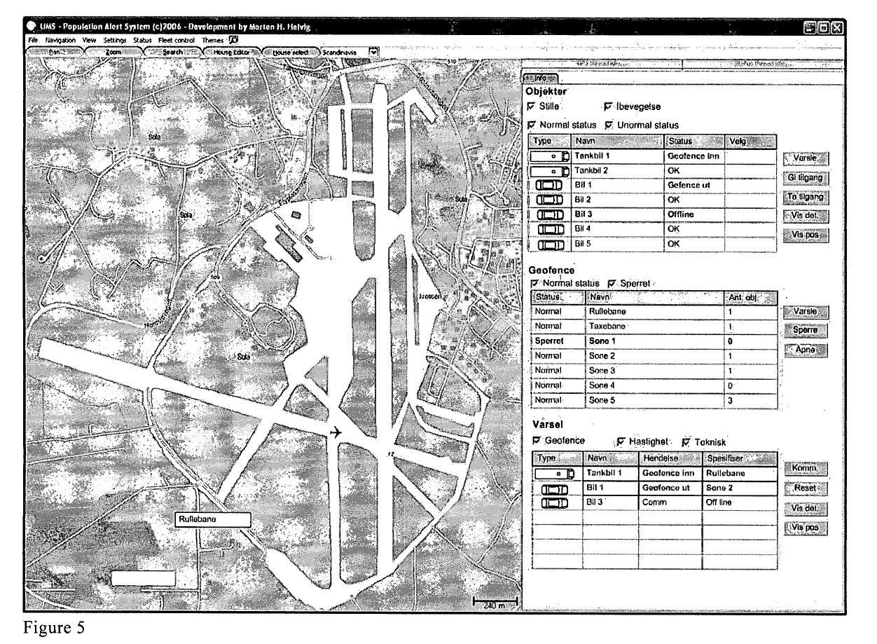

FIG. 5 shows a user interface for monitoring objects and deviations;

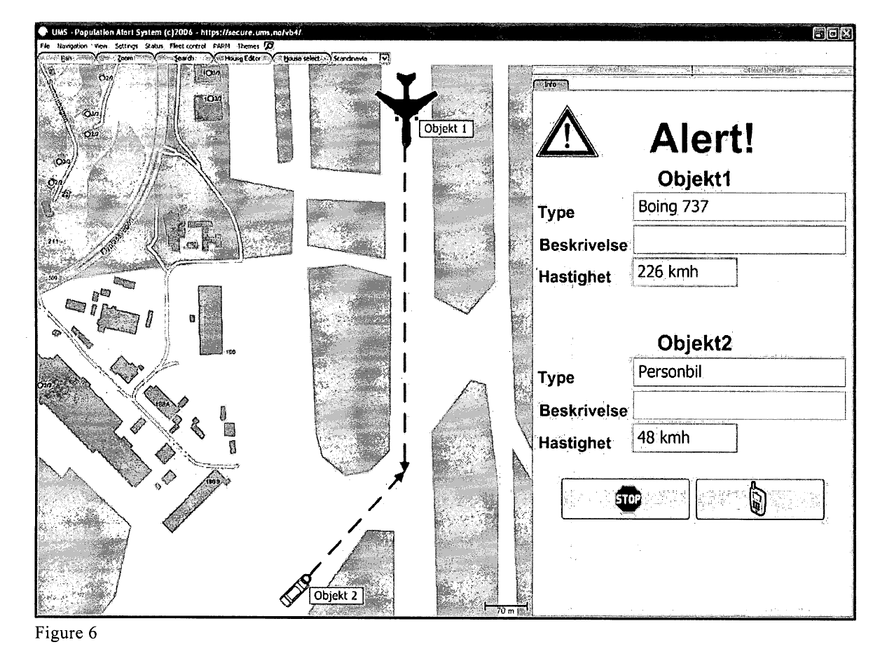

FIG. 6 shows a user interface for warning of critical deviations;

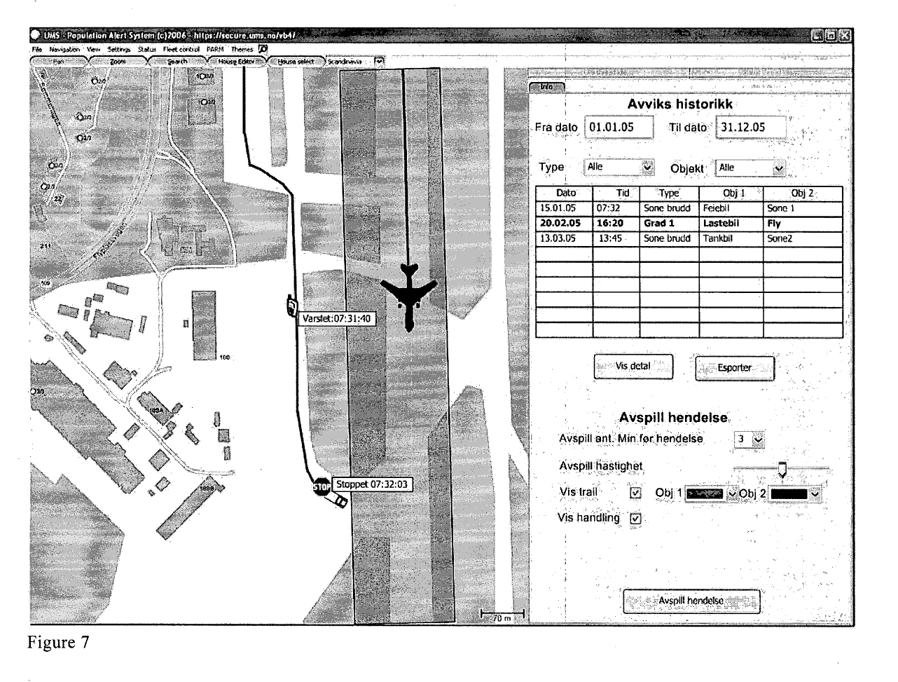

FIG. 7 shows a user interface for deviation analysis and history;

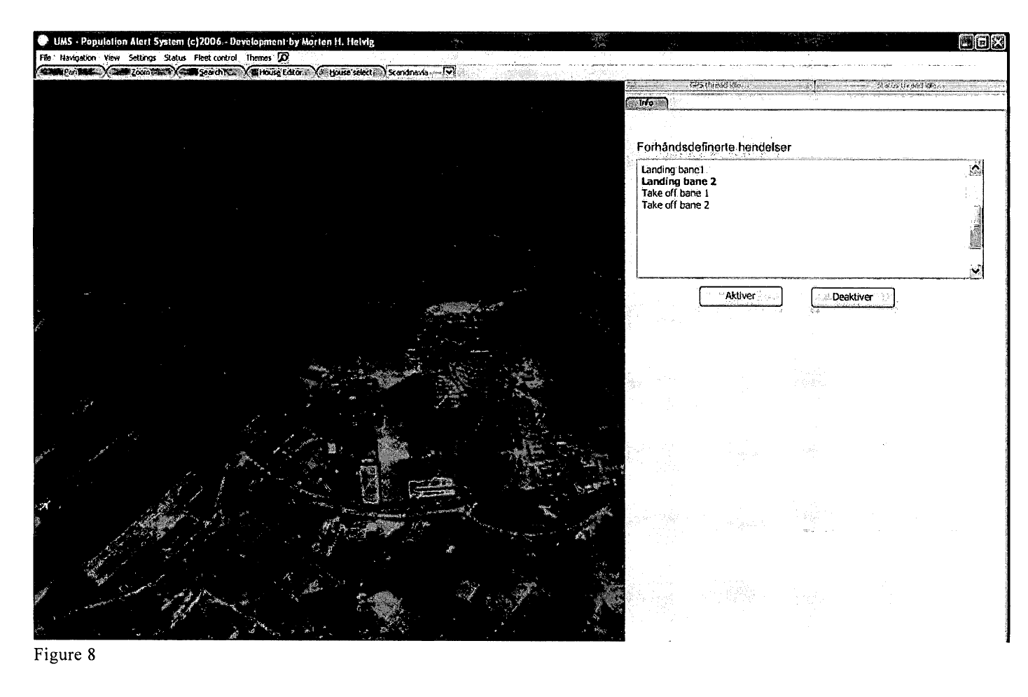

FIG. 8 shows a preferred user interface in 3D;

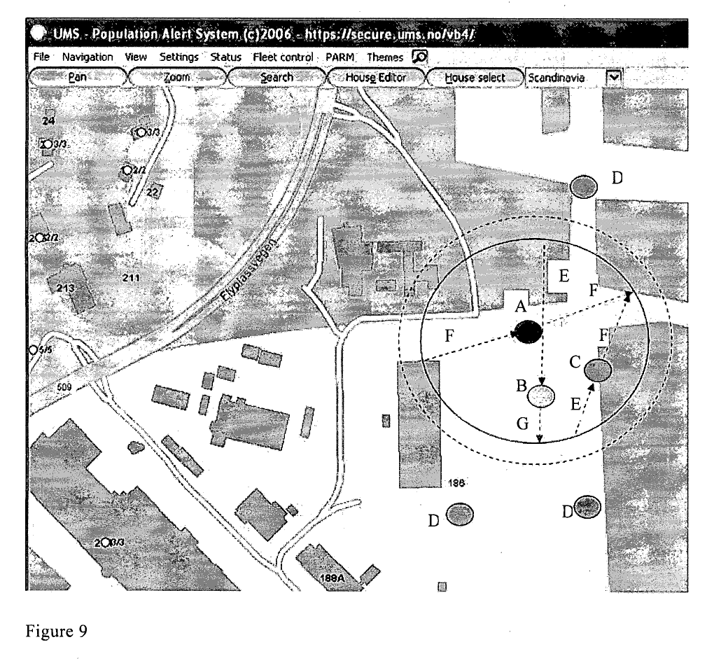

FIG. 9 shows a computation zone and a safety zone; and

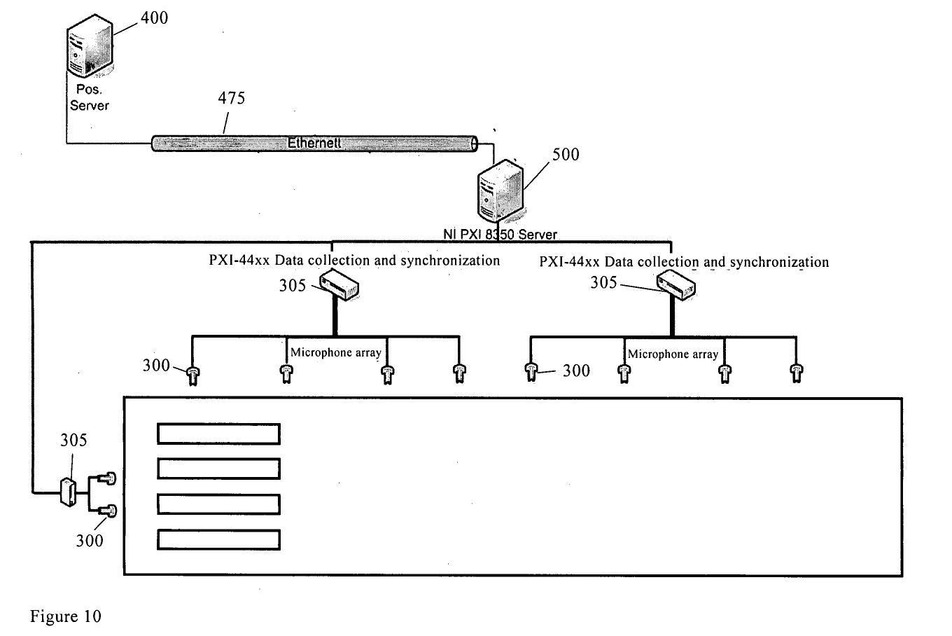

FIG. 10 shows a typical set-up for collecting sound data.

FIG. 1 shows a general architecture of a system according to the invention which is to prevent an undesired incident between moving objects within a defined area.

From the figure it can be seen that positioning means 200 are installed on an object, in this case a car 250. The positioning means 200 typically comprise GPS which receives signals from satellites 275, and means for transmitting their own position. The system further comprises sound recording means 300 for recording and interpreting sound from an object that does not have installed positioning means 200, in this case an aircraft 350. The car 250 also has warning means (not shown) for warning the driver before an undesired incident occurs.

A central unit, shown as a logic server 100, is signal-connected to the positioning means 200 and the sound recording means 300. The logic server 100 is able to receive position data and sound data direct from the positioning means 200 and the sound recording means 300 in order to then process this data. The logic server 100 is controlled from clients, shown as RIAS-clients 150.

In a preferred embodiment as shown in FIG. 1, a positioning server 400 is located between the logic server 100 and the positioning means 200. Furthermore, an acoustic analysis server 500 is located between the sound recording means 300 and the positioning server 400.

In the logic server 100 there are means for receiving, signal-processing and interpreting signals containing position information from the objects in the area in question. Rights and rules for the different objects are checked. The logic server 100 will interpret the movements of the different objects by computations and on the basis thereof anticipate hazardous situations, and then, if necessary, transmit a warning to the mobile units involved, preferably those that have positioning means 200 installed. The mobile units in question are vehicles that are registered in the system, and which are equipped with transmitting and receiving means for transmitting information about their position and for receiving a warning of an imminent undesired incident.

Registration of vehicles with installed positioning means 200 is carried out via RIAS-clients 150 which are clients running software adapted for the purpose. A RIAS-client 150 will visualise movements and incidents in a 3D-interface which gives a realistic and faithful reproduction of a situation.

The logic server 100 will thus at all times have an overview of the vehicles that are in a defined area at a given time, and the location of these vehicles at all times.

The logic server 100 also comprises means for providing warning to vehicles that are equipped with warning means.

The essence of the present invention is the interaction between the logic server 100, positioning means 200 and sound recording means 300. The logic server 100 controls this interaction.

The logic server 100 receives signals from positioning means 200, preferably via a positioning server 400. The logic server 100 also receives signals from sound recording means 300, preferably via an acoustic analysis server 500 and the positioning server 400. With a set-up of this kind, the logic server receives only position data from relevant objects that are to be assessed with regard to undesired incidents.

In what follows, the mode of operation of the invention will be described briefly. A more detailed description will be then given in the example below.

All logic and control of the system is preferably performed in the logic server 100. First, the area to be monitored is defined. This may, for example, be an area that covers the transition between taxiway and runway at an airport.

Then an overview is established of the position information of all objects, typically cars 250 of different types, with installed positioning means 200, and which are located within the defined area. At the same time an overview is established of the position information of objects, typically aircraft 350 without installed positioning means 200, based on recording and interpreting a generated acoustic image from the objects.

The position information from all objects is continuously updated in the logic server 100 in order to have an overview of the movements of the different objects, and continuous computations are made for objects that are moving at a direction and a speed which mean that it seems likely that an undesired incident may occur.

If an undesired incident is about to occur, warning will be generated, so that necessary measures for an object or objects(s) with critical direction and speed can be implemented before a dangerous situation occurs.

The flow of information between the logic server 100, positioning means 200, sound recording means 300, positioning server 400 and acoustic analysis server 500 preferably passes over wireless WLAN 450 and cabled Ethernet 475 or the like. To improve redundancy of the system, the signals can be transmitted over a GPRS-network 425 if WLAN should fail. A preferred system will therefore also comprise a router which handles a seamless transition between WLAN and GPRS.

Warning of vehicles which ought to stop or change course in order to prevent an undesired incident is generated by the logic server 100 emitting a signal, preferably a radio signal to the vehicle or vehicles in question. In the vehicle there may be mounted both a warning lamp and loudspeaker which relay the deviation message with alarm. A PDA could also be used, or fixed equipment could be mounted which show own and others' movement at the airport.

FIG. 2 shows how redundancy of the data transmission in the system is dealt with, which is extremely important. The optimal configuration will be to use WLAN 450 with GPRS 425 as a back-up channel in the event of WLAN down-time. It should be considered to regard position reporting as real time data, since positions are reported at second intervals via WLAN, and thus give them highest priority in the WLAN. In particular in the cases where the same WLAN is used for the general public, this will be important. GPRS may have a time delay in relation to WLAN, which is critical, and on transition to a back-up channel (GPRS), safety margins for all objects will automatically be extended in the event of deviation, since here there is not the same guarantee of and control over any time delays.

FIG. 3 shows how quality assurance of positions is carried out. Today's GPSs are generally of good quality, but the coverage may be poor, which means position deviations. Exact position is a necessity in a system that is based on real time monitoring of movements. Deviations may mean illogical movement of many tens of metres within a second interval which will lead to a lack of system credibility. To avoid such deviations, the system must have the capability of verifying exactness and correcting it for each position registration received.

The present invention addresses this by establishing one or more correction GPSs which in practice are static GPSs 225 with an exact known position. Deviation from these will form a basis for correction of the mobile GPSs.

The positioning server will then receive position data from both a static GPS 225 and the GPS in the positioning means 200 located in the vehicles 250. Deviations can thus be detected in the positioning server 400 and corrections in the form of correction data 410 can be implemented in a position database 420.

In practice this is done in that position from a static correction GPS 225 is received and registered in the positioning server 400 before it receives and registers the position from mobile positioning means 200. Position from a correction GPS 225 is received in the positioning server 400 and checked against the actual position that is known. Any deviations will be computed and recorded in a correction database 410. Positions from the GPSs in the mobile positioning means 200 are adjusted in accordance with the computed deviation.

FIG. 4 shows an example of an interface for registration of objects. The interface is installed on one or more RIAS clients 150. The interface is self-explanatory and will ensure rapid establishment of users, i.e., trackable GPS units which may have temporary or time-controlled access to registered areas.

FIG. 5 shows a user interface for monitoring objects and deviations. The interface shows an overview of all cars that are registered in the system and their status with associated functionality. Registered areas, so-called “geofences” with which rights are associated are also shown. Geofences can be predefined, and a dynamic geofence can be established around the area of, for example, an aircraft in motion. Status for vehicles and the number of vehicles within the geofence is shown. There is also functionality for simple opening and closing of a geofence. Lastly, the interface in the figure shows warning messages of different degrees of severity.

FIG. 6 shows a user interface for warning of a critical deviation. The operator of the system will be visually shown objects that may be involved in an undesired incident. The incident in question is focussed on and the objects in question are followed with an estimated plotted route and changes at one second intervals. Warning to a car and communication can be established by one key stroke.

FIG. 7 shows a user interface for deviation analysis and history. Typically, incidents assessed as deviations are displayed and stored. The deviation can then be shown in a reconstruction by playing back the incident in question. It is possible to choose how long a presentation is to be watched before the actual deviation incident occurs.

FIG. 8 shows a preferred user interface in 3D. A 3D interface will give a realistic and faithful reproduction of a situation. Such an interface means that the user can choose different perspectives from different virtual camera angles. The interface is rational since all objects are seen in the right direction and perspective, and a rapid focussing on a deviation will be obtained.

FIG. 9 is a basic diagram showing the method for computing relationships between objects. The figure shows a computation zone and a safety zone in connection with deviations in GPS or WLAN. The inner circle indicates normal computation area, and the circle drawn in a broken line indicates the computation area in the event of a registered deviation in GPS or WLAN. Only objects which are within computation areas will be included in the assessment.

A indicates the actual object to which the computation relates.

B indicates the objects that are within the defined area, i.e., the clearance zone, but which have non-critical movement.

C describes the objects that are within the defined area, and which have a critical movement.

D indicates objects that are outside the computation area.

E is the broken line showing the actual distance already covered by an object. The broken lines F show computed movement of an object with a critical line between two objects. Computation of future movement (position, speed, direction, acceleration/retardation) is based on history.

G indicates computed movement of an object with a non-critical relationship with the object A in question.

Rules and limit values for object relation associated with the individual objects and geofences makes it possible to predict critical relationships between objects (for example, possible points of interception between objects) based on the above.

Exceeding a limit value between objects generates an automatic incident in the system. Incidents are graded on the basis of their degree of severity. User-defined actions such as warning of different types can be automatically executed in connection with the incident.

FIG. 10 shows a typical set-up for gathering sound data on a runway. This is a proposed structure that is intended to serve as an example to explain the mode of operation.

A plurality of microphones 300 are placed by the runway. The signals from the microphones 300 are collected in synchronisation and analysis units 305. Monitoring and recording start with a certain type of sound, for example, the sound of an aircraft. The aircraft type is identified and the position found from a combination of sound from each individual microphone whose position is known. An acoustic analysis server 500 collects data from all the synchronisation and analysis servers 305 and converts the data for transmission of object type and position to the positioning server 400.

As mentioned above, the essence of the invention is to combine sound data and position data so as to be able to determine position and expected movement for all types of objects within a selected area, both those equipped with positioning means and those not equipped with such means.

For a person of skill in the art it is obvious that there are many different ways of implementing such a system. The actual invention is set forth in the independent claims, and the implementation that can be seen from the description above is intended to be an example of how this can be solved.

1. A method for preventing an undesired incident between moving objects within a defined area,
wherein the method comprises the following steps executed in a central unit:
establishing an overview, including position information of objects with installed positioning means, and which are located within the defined area, the positioning means reporting their position;
establishing an overview of position information of objects without installed positioning means, based on recording and interpreting generated acoustic image from the objects;
continuously updating the position information from all objects in order to establish an overview of the movements of the different objects;
computing, from the movements, future direction and speed of the different objects;
making further continuous computations for objects that are moving at a direction and speed which mean that it can be anticipated that an undesired incident may occur;
providing a warning, so that necessary measures for an object or objects with critical direction and speed can be implemented before an undesired incident can occur.

2. A method according to claim 1,
wherein the overview of position information includes position information from fixed stationary positioning means in order, if necessary, to be able to correct the position reported from objects with installed positioning means.

3. A method according to claim 1,
wherein the moving objects are cars and aircraft, and the defined area is an area at an airport.

4. A method according to claim 1,
wherein the central unit is a logic server which receives signals comprising position information from objects equipped with positioning means, and which receives signals that describe the acoustic image from objects not equipped with positioning means.

5. A method according to claim 4,
wherein the logic server comprises means for interpreting the received acoustic image and converting the sound signals into position data.

6. A method according to claim 1,
wherein the central unit is a logic server which receives signals comprising position information from objects equipped with positioning means, and which further, via an acoustic analysis server that is connected to one or more microphones, receives signals comprising position information of objects without installed positioning means.

7. A method according to claim 6,
wherein the signals to the logic server are received over WLAN and/or GPRS.

8. A method according to claim 1,
wherein the position information received is based on GPS.

9. A method according to claim 1,
wherein warning is provided in that the central unit emits a radio signal that can be received and interpreted by objects that may be involved in an undesired incident.

10. A system for preventing an undesired incident between moving objects within a defined area,
wherein the system comprises:
positioning means installed on objects which are registered in the system;
means for recording and interpreting sound from objects without installed positioning means;
warning means for warning the driver of an object before an undesired incident may occur;
a central unit which is signal-connected to the positioning means and the means for recording and interpreting sound, and also to the warning means, and where the central unit has means for receiving, signal-processing and interpreting signals containing information about the objects in the area in question, and where the central unit further has means for providing a warning to the warning means.

11. A system according to claim 10, wherein the positioning means are GPS receivers with transmitters for transmitting their respective positions to the central unit.

12. A system according to claim 10, wherein the means for recording sound are one or more microphones, and the means for interpreting sound are a signal processing unit.

13. A system according to claim 10, wherein the signal connection is in the form of a WLAN and/or GPRS network.

14. A system according to claim 10, wherein the warning means towards objects belonging to the defined area are generated towards separate units mounted in the objects, the warning being generated both acoustically and visually.

15. A system according to claim 10, wherein the warning signals from the central unit to the warning means are transmitted via WLAN and/or GPRS.

16. A system according to claim 10, wherein the warning signals from the central unit to the warning means are transmitted by means of an automated dial-up via the mobile telephone network or other communication channels.

17. A system according to claim 16, wherein other communication channels are VHF or other closed radio circuits.

18. A system according to claim 10, wherein the system also comprises a GIS based interface which in real time visualises the movements of all objects within the defined area.
